(19) United States
(12) Patent Application Publication
(10) Pub. No.: US 2014/0286021 A1
(43) Pub. Date: Sep. 25, 2014

(54) Lamp Device and Luminaire

(71) Applicant: TOSHIBA LIGHTING & TECHNOLOGY CORPORATION, Yokosuka-shi (JP)

(72) Inventors: Junichi Kimiya, Yokosuka-shi (JP); Masazumi Ishida, Yokosuka-shi (JP); Makoto Otsuka, Tokyo (JP)

(73) Assignee: TOSHIBA LIGHTING & TECHNOLOGY CORPORATION, Yokosuka-shi (JP)

(21) Appl. No.: 14/029,892

(22) Filed: Sep. 18, 2013

(30) Foreign Application Priority Data
Mar. 22, 2013 (JP) 2013-060247

(51) Int. Cl. F21V 29/00

(52) U.S. Cl. CPC F21V 29/004
USPC 362/373

(57) ABSTRACT

According to one embodiment, a projection projects in the rear side center portion of a housing. A light-emitting module is arranged in the housing. A pair of power-supply sections configured to supply electric power to the light-emitting module is arranged around a light-emitting section in the housing. An information circuit configured to output information to the outside is arranged in a position around the light-emitting section and different from the positions of the pair of power-supply sections in the housing. A plurality of pins are provided at intervals along the rear side peripheral portion of the housing around the projection. Connecting means connects the power-supply sections and the pins located near the power-supply sections and connects the information circuit and the pin located near the information circuit.

### INCORPORATION BY REFERENCE

The present invention claims priority under 35 U.S.C, §119 to Japanese Patent Application No. 2013-060247 filed on Mar. 22, 2013. The content of the application is incorporated herein by reference in their entirety.

### FIELD

Embodiments described herein generally relate to a lamp device including a light-emitting module and a luminaire including the lamp device.

### BACKGROUND

Hitherto, in a lamp device including a light-emitting module, a translucent member is arranged on the front surface side, which is a light emission side of a housing, and a projection including a thermal radiation section is protrudingly provided on the rear side opposite to the front surface side. In the housing, the light-emitting module is arranged on the front side of the thermal radiation section, and a reflector and a lighting circuit are arranged further on the front side than the light-emitting module.

A plurality of pins are protrudingly provided from the rear side peripheral portion of the housing around the projection. The pins include two pins for power supply of alternating-current power, two pins for dimming signal input, and one pin for earth. The plurality of pins are connected to a lighting circuit.

However, when the lamp device includes a plurality of pins for power supply and for signals, it is likely that, a wiring distance for connecting the pins and connecting places corresponding to the pins increases or wires cross, a wiring structure is complicated and a wiring error occurs.

### BRIEF DESCRIPTION OF THE DRAWINGS

FIG. 1 is a rear view of a lamp device according to a first embodiment;

FIG. 2 is a wiring diagram of a plurality of pins and a light-emitting module and an information circuit of the lamp device;

FIG. 3 is a sectional view of the lamp device;

FIG. 4 is an exploded perspective view of the lamp device;

FIG. 5 is a perspective view of the rear side of the lamp device;

FIG. 6 is a sectional view of the lamp device;

FIG. 7 is a perspective view of the lamp device and a socket; and

FIG. 8 is a sectional view of a lamp device according to a second embodiment.

### DETAILED DESCRIPTION

In general, according to one embodiment, a lamp device includes a housing, a light-emitting module, a pair of power-supply sections, an information circuit, a plurality of pins, and connecting means. In the housing, a projection including a thermal radiation section is projected in the rear side center portion opposite to the front side, which is a light emission side. The light-emitting module includes a substrate and a light-emitting section formed on the substrate. The light-emitting section is arranged in the center of the housing. The substrate is thermally connected to the thermal radiation section. The pair of power-supply sections is arranged around the light-emitting section in the housing and configured to supply electric power to the light-emitting module. The information circuit is arranged in a position around the light-emitting section and different from the positions of the pair of power-supply sections in the housing and configured to output information to the outside. The plurality of pins are provided at intervals along the rear side peripheral portion of the housing around the projection. The connecting means connects the respective power-supply sections and the pins located near the respective power-supply sections and connects the information circuit and the pin located near the information circuit.

The pair of power-supply sections and the information circuit can be arranged in different positions around the light-emitting section in the housing, the power-supply sections and the pins located near the power-supply sections can be connected by the connecting means, and the information circuit and the pin located near the information circuit can be connected by the connecting means. Therefore, it is possible to simplify a wiring structure.

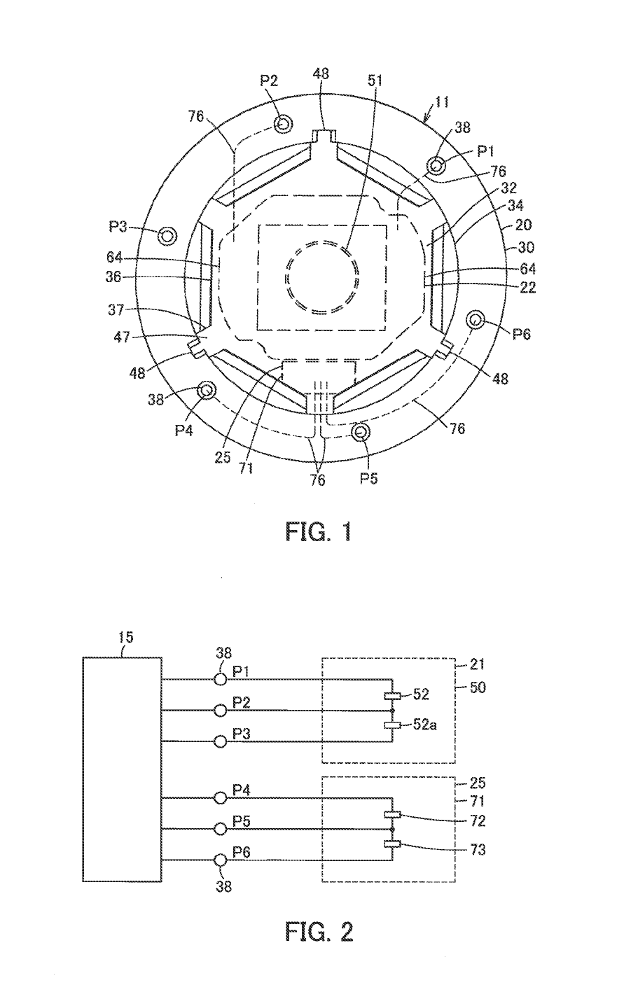

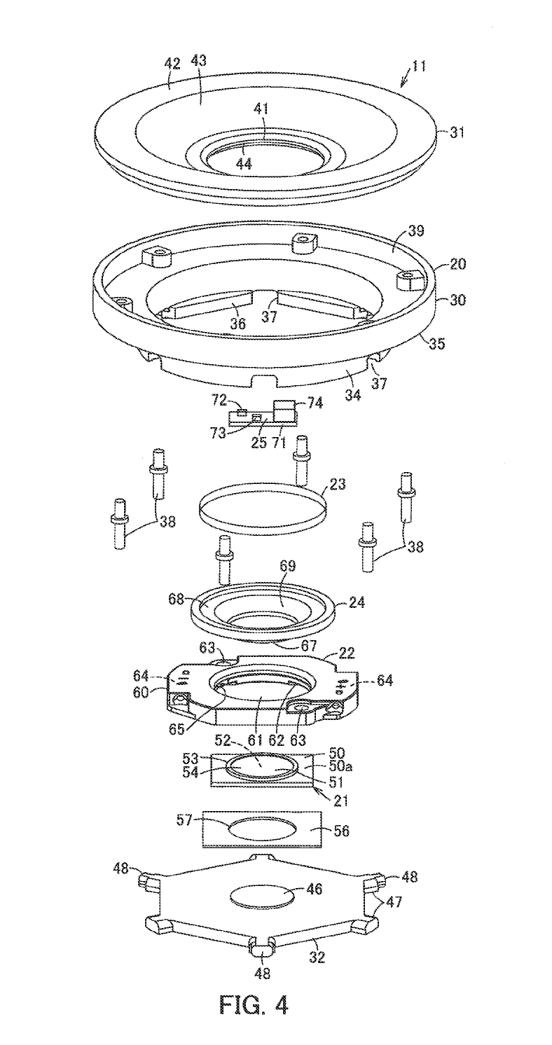

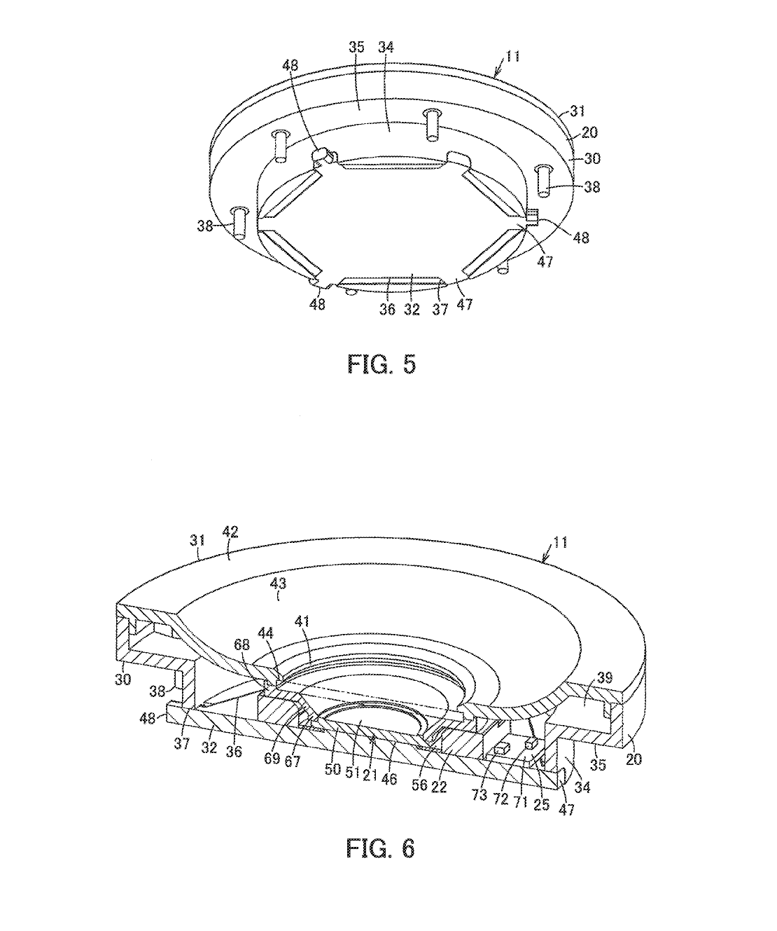

A first embodiment is explained below with reference to FIGS. 1 to 7.

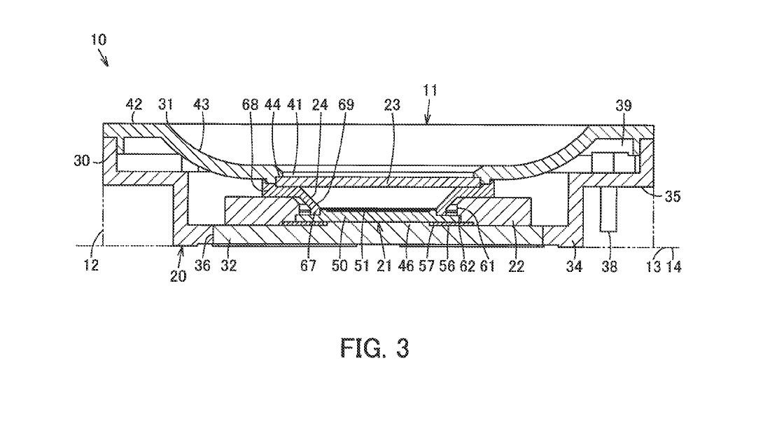

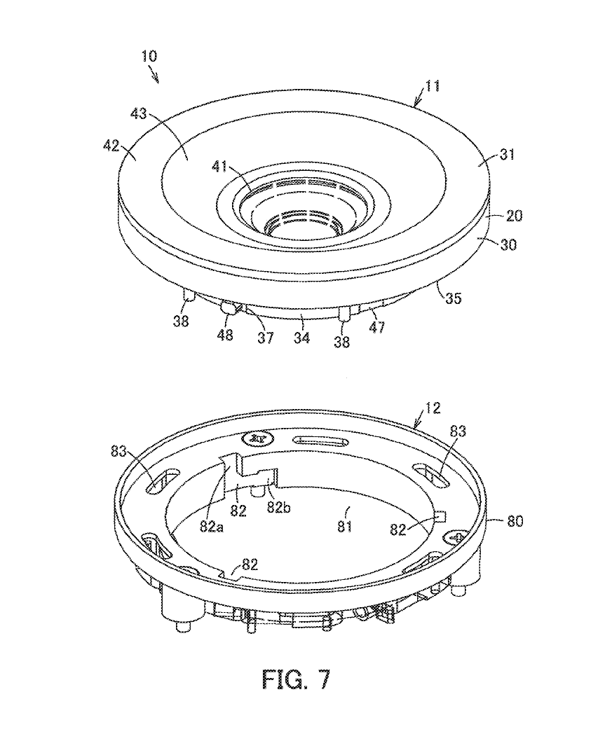

As shown in FIGS. 3 and 7, a luminaire 10 includes a lamp device 11, a socket 12 to which the lamp device 11 is detachably attached, a luminaire main body 14 including a thermal radiator 13 to which the lamp device 11 attached to the socket 12 is thermally connected, and a lighting circuit 15 (see FIG. 2) arranged in the luminaire main body 14 or the like and electrically connected to the lamp device 11 through the socket 12. The lighting circuit 15 is configured to convert commercial alternating-current power into predetermined direct-current power and supply the direct-current power to the lamp device 11 and receive an information signal output from the lamp device 11 and control the lamp device 11. In the figure, a light emitting direction of the lamp device 11 is shown as the upward direction. However, when the luminaire 10 is, for example, a downlight, the light emitting direction of the lamp device 11 is the downward direction. When the luminaire 10 is, for example, a wall-surface attached luminaire, the light emitting direction of the lamp device 11 is the lateral direction. A light emission side of the lamp device 11 is referred to as front side. The opposite side of the light emission side is referred to as rear side.

As shown in FIGS. 3 to 6, the lamp device 11 includes a housing 20, a light-emitting module 21, a holder 22, a translucent member 23, a non-translucent member 24, and an information circuit 25.

The housing 20 includes a main body 30, a cover 31 attached to the front side of the main body 30, and a thermal radiation section 32 attached to the rear side of the main body 30.

The main body 30 is made of, for example, synthetic resin and formed in an annular shape, the center portion of which is opened in the front back direction. A cylindrical projection 34 is projected in the rear side center portion of the main body 30. An annular step section 35, which fits in the socket 12, is formed in the rear side peripheral portion of the main body 30 around the projection 34. A hexagonal fitting opening 36, in which the thermal radiation section 32 fits, is formed on the distal end face of the projection 34. Groove sections 37 communicating with the circumferential surface of the projection 34 are formed to correspond to apex positions of the fitting opening 36. A plurality of pins 38 having electric conductivity are protrudingly provided on the rear side surface of the step section 35 with a predetermined space apart from one another in the circumferential direction. In this embodiment, six pins 38 in total including three pins 38 for power supply and three pins 38 for signals are used. A wiring space 39 for electrically connecting the plurality of pins 38 and the light-emitting module 21 and the information circuit 25 is formed between the step section 35 and the cover 31 and in the peripheral portion in the housing 20.

The cover 31 is made of, for example, synthetic resin. A circular opening section 41 is formed in the center portion of the cover 31. An annular frame section 42 attached to the peripheral portion of the main body 30 is formed in the peripheral portion of the cover 31. A bowl-like hollow section 43, which hollows the opening section 41 to the rear side with respect to the frame section 42, is formed between the opening section 41 and the frame section 42. The front side peripheral edge portion of the opening section 41 is formed in a taper shape to expand toward the front side. A fitting section 44, in which the translucent member 23 is fit, is formed in the rear side peripheral edge portion of the opening section 41. For example, a white reflecting surface may be formed on the front side surface of the cover 31.

The thermal radiation section 32 is made of metal such as aluminum and formed in a hexagonal flat shape. A circular projecting section 46 is projected on the front side surface of the thermal radiation section 32. Protrusions 47, which fit in the groove sections 37 of the main body 30, are protrudingly provided in apex positions of the peripheral portion of the thermal radiation section 32. Keys 48 are protrudingly provided at the distal ends of several protrusions 47 among the protrusions 47. In this embodiment, six protrusions 47 are provided. The keys 48 are provided in every other three protrusions 47 among the six protrusions 47. One of the plurality of keys 48 are formed wider than the other keys 48.

The light-emitting module 21 includes a flat substrate 50 and a light-emitting section 51 formed in the center of a mounting surface 50a, which is the front side surface of the substrate 50. The substrate 50 is formed of a material excellent in heat conductivity, for example, metal such as aluminum or ceramics. In the light-emitting section 51, for example, LED chips functioning as a plurality of light-emitting elements 52 are densely mounted on the substrate 50, translucent resin 54 containing a phosphor is filled in an annular surrounding section 53 surrounding the LED chips, and the surface of the translucent resin 54 covering the LED chips is formed as a circular light-emitting surface that emits light. That is, the light-emitting module 21 is configured by a COB (Chip On Board) module. Although not shown in the figure, a wiring pattern for electrically connecting the plurality of LED chips is formed on the mounting surface 50a of the substrate 50. A pair of electrode sections for supplying electric power to the plurality of LED chips through the wiring pattern is formed in the peripheral portion of the mounting surface 50a.

In the light-emitting module 21, the rear side surface of the substrate 50 is directly set in contact with and thermally connected to the front side surface of the projecting section 46 of the thermal radiation section 32. The light-emitting section 51 is formed in an external shape having the same size as the projecting section 46 or an external shape smaller than the projecting section 46. The light-emitting section 51 is arranged to be located within an external shape region of the projecting section 46. The substrate 50 is formed in an external shape larger than the external shape of the projecting section 46.

An insulating sheet 56 is interposed between the thermal radiation section 32 and the peripheral portion of the substrate 50 around the projecting section 46. The insulating sheet 56 is, for example, a silicone sheet having elasticity. An insert-through hole 57, through which the projecting section 46 is inserted, is formed in the center of the insulating sheet 56. The insulating sheet 56 is formed in an external shape larger than the external shape of the substrate 50 and smaller than the external shape of the thermal radiation section 32. Further, the insulating sheet 56 is sandwiched and compressed between the thermal radiation section 32 and the substrate 50.

The holder 22 includes a holder main body 60 made of, for example, synthetic resin. The holder main body 60 is formed in an annular shape including, in the center portion, a circular opening section 61 opened in the front back direction. A holding groove 62, in which the peripheral portion of the substrate 50 is fit, is formed on the rear side surface of the holder main body 60. The diameter of the opening section 61 of the holder main body 60 is formed larger than the diameter of the light-emitting section 51. The light-emitting section 51 is opposed to the front through the opening section 61 of the holder main body 60.

A plurality of attachment holes 63 are formed in the holder main body 60. The holder main body 60 is attached to the thermal radiation section 32 in a state in which the substrate 50 is pressed against the thermal radiation section 32 by screwing screws into the thermal radiation section 32 through the attachment holes 63.

In the holder main body 60, a pair of power-supply sections 64 is provided in symmetrical positions centered upon the opening section 61. In the pair of power-supply sections 64, not-shown connection terminals for electrically connecting electric wires for power supply inserted into the respective power-supply sections 64 are disposed. Further, contact terminals 65 respectively set in pressed contact with and electrically connected to a pair of electrode sections connected to the connection terminals and formed on the mounting surface 50a of the substrate 50 are disposed.

The translucent member 23 is formed in a disc shape by a synthetic resin material or a glass material having translucency. The peripheral portion of the translucent member 23 is fit in the fitting section 44 from the rear side of the cover 31 and sandwiched and held between the fitting section 44 and the non-translucent member 24. The translucent member 23 may have a lens function for controlling luminous intensity distribution.

The non-translucent member 24 is formed in a cylindrical shape having elasticity and non-translucency (light blocking property) by, for example, silicone resin. The non-translucent member 24 allows the light-emitting section 51 and the translucent member 23 to communicate with each other and covers the periphery between the light-emitting section 51 and the translucent member 23 to prevent light from leaking to the periphery. The non-translucent member 24 includes a first attachment section 67 fit in the periphery of the surrounding section 53 of the light-emitting section 51 and set in pressed contact with the front side surface of the substrate 50 and a second attachment section 68 sandwiched and held between the cover 31 and the translucent member 23 and the holder 22. A taper-shaped covering section 69 expanding in an inner diameter from the first attachment section 67 to the second attachment section 68 is formed between the first attachment section 67 and the second attachment section 68. The inner circumferential surface of the covering section 69 may be formed as a reflecting surface having high reflectance.

The information circuit 25 outputs information of the lamp device 11 to the lighting circuit 15. The information includes temperature information and lamp characteristic information. The information circuit 25 includes a circuit board 71. The circuit board 71 is mounted with a temperature detecting section 72 configured to detect temperature and output temperature information, a lamp-characteristic output section 73 configured to output a lamp characteristic such as a lamp output (input power), and a connector 74 for electrical connection. The circuit board 71 is arranged on the front side surface of the thermal radiation section 32 and enables the temperature detecting section 72 to detect the temperature of the thermal radiation section 32. In the temperature detecting section 72, a temperature detecting element, an electric current flowing to which changes according to temperature, is used. In the lamp-characteristic output section 73, a resistor having resistance determined in advance according to the lamp characteristic such as a lamp output (input power) is used, for example.

In FIG. 2, a wiring diagram of the plurality of pins 38 and the light-emitting module 21 and the information circuit 25 is shown. The pin 38 P1 is a 4-pole for power supply, the pin 38 P2 is a − pole for power supply, the pin 38 P3 is an auxiliary pin and, for example, when a light-emitting element 52a having a light emission color different from a light emission color of the light-emitting elements 52 is added, functions as a + pole for power supply to the added light-emitting element 52a, the pin 38 P4 is a temperature information output pole for signals, the pin 38 P5 is a common pole for signals, and the pin 38 P6 is a lamp characteristic signal output pole for signals. The pins 38 P1 to P3 are connected to power-supply terminals of the lighting circuit 15 through the socket 12. The pins 38 P4 to P6 are connected to signal terminals of the lighting circuit 15 through the socket 12.

As shown in FIG. 1, the pair of power-supply sections 64 and the information circuit 25 are arranged in different positions in the circumferential direction around the light-emitting section 51. Among the plurality of pins 38, the pins 38 P1 to P3 are arranged near the pair of power-supply sections 64 and the pins 38 P4 to P6 are arranged near the information circuit 25. The pins 38 P1 and P2 and the pair of power-supply sections 64 are electrically connected, and the pins 38 P4 to P6 and the information circuit 25 are electrically connected by connecting means 76 such as electric wires. As the connecting means for the pins 38 P4 to P6 and the information circuit 25, electric wires with connectors connectable to the connector 74 of the circuit board 71 are used.

As shown in FIG. 7, the socket 12 includes a socket main body 80 formed in an annular shape by, for example, synthetic resin. An insert-through hole 81, through which the projection 34 of the lamp device 11 is inserted, is formed in the center of the socket main body 80. A plurality of key grooves 82, to which the keys 48 of the lamp device 11 are attached, are provided on the inner circumferential surface of the insert-through hole 81. The key groove 82 is formed in a substantial L shape configured by a longitudinal groove 82a formed along the front back direction and a lateral groove 82b formed along the circumferential direction on the rear side of the longitudinal groove 82a. One of the plurality of key grooves 82 is formed wider than the other key grooves 82 to correspond to the one key 48 formed wider.

On the front side surface of the socket main body 80, insertion holes 83, into which the respective pins 38 of the lamp device 11 are inserted, are formed in a long-hole shape in the circumferential direction. Terminals electrically connected to the respective pins 38 are respectively arranged on the respective inner sides of the insertion holes 83.

When the lamp device 11 is attached to the socket 12, the one wide key 48 of the lamp device 11 and the one wide key groove 82 of the socket 12 are aligned, and the respective keys 48 are inserted into the longitudinal grooves 82a of the respective key grooves 82. Consequently, the projection 34 of the lamp device 11 is inserted into the insert-through hole 81, and the pins 38 are inserted into the respective insertion holes 83 corresponding thereto.

After the lamp device 11 is aligned with and inserted into the socket 12, the lamp device 11 is turned in a predetermined attaching direction, whereby the respective keys 48 enter the lateral grooves 82b of the respective key grooves 82 and the lamp device 11 is held by the socket 12. Consequently, the respective pins 38 are electrically connected to the terminals arranged on the inner sides of the insertion holes 83.

By attaching the lamp device 11 to the socket 12, the thermal radiation section 32 is thermally connected to the thermal radiator 13 of the luminaire main body 14. The socket 12 is attached to the thermal radiator 13 to be movable in the front back direction and energized toward the thermal radiator 13 by a spring. When the respective keys 48 engage in the lateral grooves 82b of the respective key grooves 82, the socket 12 separates and moves from the thermal radiator 13, whereby the thermal radiation section 32 of the lamp device 11 is brought into pressed contact with the thermal radiator 13 by spring energization, and satisfactory heat conductivity is secured.

By attaching the lamp device 11 to the socket 12, the pins 38 P1 to P3 connected to the power-supply sections 64 of the lamp device 11, and the power-supply terminals of the lighting circuit 15 are electrically connected and the pins 38 P4 to P6 connected to the information circuit 25, and the signal terminals of the lighting circuit 15 are electrically connected.

Consequently, the lighting circuit 15 transmits a predetermined input signal to the information circuit 25 of the lamp device 11, receives an information signal from the information circuit 25, and acquires temperature information and lamp characteristic information. The lighting circuit 15 controls, based on the acquired information, direct-current power supplied to the lamp device 11. For example, when the lamp device 11 having a lamp output corresponding to a thermal radiation ability on the luminaire side or the lamp device 11 having a low lamp output is attached, the lighting circuit 15 supplies direct-current power corresponding to the lamp output of the lamp device 11 on the basis of the lamp characteristic information. On the other hand, when the lamp device 11 having a high lamp output is attached, the lighting circuit 15 performs, on the basis of the lamp characteristic information, dimming control to suppress the direct-current power to be supplied. When the temperature of the lamp device 11 rises to temperature determined in advance, the lighting circuit 15 performs, based on the basis of the temperature information, control to dim light to reduce a light output or extinguish the light.

Heat generated from the light-emitting elements 52 according to the lighting of the lamp device 11 is conducted from the substrate 50 to the projecting section 46 of the thermal radiation section 32 and conducted from the thermal radiation section 32 to the thermal radiator 13 to be radiated. Consequently, a temperature rise of the light-emitting elements 52 is suppressed.

In the lamp device 11, the opening section 41 of the cover 31 is located further on the rear side than the frame section 42, which is the peripheral portion of the cover 31, and the translucent member 23 arranged in the opening section 41 of the cover 31 is located further on the rear side than the frame section 42, which is the peripheral portion of the cover 31. Consequently, since the translucent member 23 is arranged in a position close to the light-emitting section 51, most of light emitted from the light-emitting section 51 tends to pass through the translucent member 23 to be emitted to the outside. Light reflected in the housing 20 decreases, and a light loss in the housing 20 is reduced. Therefore, it is possible to improve light extracting efficiency of the lamp device 11.

Moreover, even if a projection amount of the projecting section 46 of the thermal radiation section 32, to which the light-emitting module 21 is attached, is not increased, the translucent member 23 and the light-emitting module 21 can be set dose to each other. Therefore, it is possible to reduce the projecting section 46 of the thermal radiation section 32 in thickness and weight and reduce the lamp device 11 in thickness.

Further, since the translucent member 23 is set close to the light-emitting section 51, it tends to be difficult to secure a space for connecting the plurality of pins 38 and the light-emitting module 21 and the information circuit 25 in the housing 20. However, if the wiring space 39 is provided further on the front side than the translucent member 23 in the peripheral portion in the housing 20, it is possible to provide the wiring space 39 effectively using a space in the housing 20.

The light-emitting section 51 and the translucent member 23 are allowed to communicate with each other by the non-translucent member 24. The periphery between the light-emitting section 51 and the translucent member 23 is covered by the non-translucent member 24 to prevent light from leaking to the periphery. Consequently, it is possible to prevent light from the light-emitting section 51 from being made incident on the holder 22, the connector 74, and the like and prevent heat generation, discoloration, and deformation of the holder 22 and the connector 74. It is possible to prevent gas from being generated when the light from the light-emitting section 51 is made incident on resin components forming the holder 22 and the connector 74 to generate heat and prevent the light-emitting section 51 from being affected by the gas. If the inner circumferential surface of the covering section 69 of the non-translucent member 24 is formed as a reflecting surface having high reflectance, light reflected on the reflecting surface can also be emitted to the outside from the translucent member 23. Therefore, it is possible to improve the light extracting efficiency of the lamp device 11.

Among the plurality of keys 48 of the lamp device 11, any one or plurality of keys 48 are formed different in a shape, for example, wider than the other keys 48, and the key grooves 82 of the socket 12 are formed to correspond to the keys 48. Consequently, it is possible to set a large number of patterns for specifying a combination of the lamp device 11 and the socket 12. Further, according to presence or absence of the auxiliary pin 38 in the lamp device 11 or by opening the insertion hole 83 of the socket 12 corresponding to the auxiliary pin 38 or dosing the insertion hole 83 with a closing member, it is also possible to set a large number of patterns for specifying a combination of the lamp device 11 and the socket 12.

The center portion of the substrate 50 corresponding to the region of the light-emitting section 51 of the light-emitting module 21 is thermally connected to the projecting section 46 of the thermal radiation section 32. Therefore, it is possible to efficiently conduct heat generated by the light-emitting section 51 to the thermal radiation section 32 and improve thermal radiation properties. Moreover, the substrate 50 of the light-emitting module 21 is larger than the external shape of the projecting section 46 of the thermal radiation section 32, and the insulating sheet 56 is interposed between the substrate 50 and the thermal radiation section 32. Consequently, it is possible to sufficiently obtain an insulation distance between the mounting surface 50a, which is the front side surface of the substrate 50 on which the light-emitting section 51 is formed, and the thermal radiation section 32 and improve insulation properties.

Further, the shape of the insulating sheet 56 is larger than the external shape of the substrate 50 and smaller than the external shape of the thermal radiation section 32. Therefore, it is possible to sufficiently obtain the insulation distance between the mounting surface 50a of the substrate 50 and the thermal radiation section 32 and improve insulation properties.

The insulating sheet 56 is sandwiched and compressed between the thermal radiation section 32 and the substrate 50. Therefore, it is possible to eliminate a space between the insulating sheet 56 and the thermal radiation section 32 and the substrate 50 and improve insulation properties.

The pair of power-supply sections 64 and the information circuit 25 can be arranged in different positions around the light-emitting section 51 in the housing 20. The power-supply sections 64 and the pins 38 located near the power-supply sections 64 can be connected by the connecting means 76. The information circuit 25 and the pins 38 located near the information circuit 25 can be connected. The connecting means 76 does not cross. It is possible to simplify a wiring structure, facilitate manufacturing, and prevent a wiring error.

Further, the information circuit 25 is the temperature detecting section 72 configured to detect temperature and output temperature information and the lamp-characteristic output section 73 configured to output lamp characteristic information. Consequently, it is possible to appropriately control the lamp device 11 with the lighting circuit 15 that acquires these kinds of information.

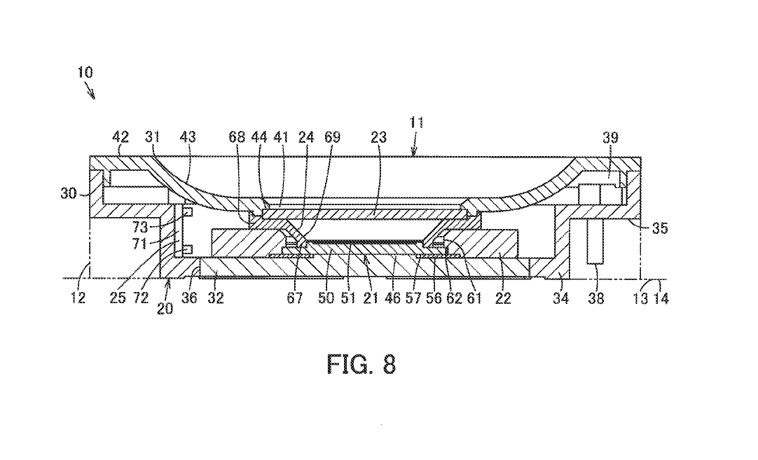

A second embodiment is shown in FIG. 8. Components and action and effects same as those in the first embodiment are denoted by the same reference numerals and signs and explanation of the components and the action and effects is omitted.

The circuit board 71 of the information circuit 25 is arranged along the inner side surface of the projection 34. The temperature detecting section 72 is arranged on the thermal radiation section 32 side of the circuit board 71. The lamp-characteristic output section 73 is arranged on the opposite side of the thermal radiation section 32 side. With such a configuration, it is possible to accurately detect the temperature of the thermal radiation section 32 with the temperature detecting section 72 and reduce the influence of heat on the lamp-characteristic output section 73.

In the respective embodiments, as the translucent member 23, the translucent member 23 containing a phosphor excited by an input of light from the light-emitting elements 52 of the light-emitting section 51 to emit predetermined light may be used. In this case, in the light-emitting section 51, the translucent resin 54 may or may not contain a phosphor. Alternatively, the translucent resin 54 itself does not have to be used. For example, if the translucent member 23 containing a phosphor corresponding to a characteristic change such as a color temperature difference or an average color rendering index (Ra) difference of emitted light from the lamp device 11 is prepared and used for the lamp device 11, it is possible to share the light-emitting module 21 and easily cope with the characteristic difference.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lamp device comprising:
a housing in which a projection including a thermal radiation section is projected in a rear side center portion opposite to a front side, which is a light emission side;
a light-emitting module including a substrate and a light-emitting section formed on the substrate, the light-emitting section being arranged in a center of the housing and the substrate being thermally connected to the thermal radiation section;
a pair of power-supply sections arranged around the light-emitting section in the housing and configured to supply electric power to the light-emitting module;
an information circuit arranged in a position around the light-emitting section and different from positions of the pair of power-supply sections in the housing and configured to output information to the outside;
a plurality of pins provided at intervals along a rear side peripheral portion of the housing around the projection; and
connecting means for connecting the power-supply sections and the pins located near the power-supply sections and connecting the information circuit and the pin located near the information circuit.

2. The device according to claim 1, wherein the information circuit includes a temperature detecting section configured to detect temperature and output temperature information.

3. The device according to claim 1, wherein the information circuit includes a lamp-characteristic output section configured to output lamp characteristic information.

4. The device according to claim 1, wherein
the information circuit is arranged along an inner side surface of the projection,
a temperature detecting section configured to detect temperature and output temperature information is arranged on the thermal radiation section side, and
a lamp-characteristic output section configured to output lamp characteristic information is arranged on an opposite side of the thermal radiation section side.

5. The device according to claim 1, wherein
the pins located in one region of two regions formed by dividing a region of the rear side peripheral portion of the housing into two and the power-supply sections are connected, and
the pin located in the other region and the information circuit are connected.

6. A luminaire comprising:
a lamp device including:
a housing in which a projection including a thermal radiation section is projected in a rear side center portion opposite to a front side, which is a light emission side;
a light-emitting module including a substrate and a light-emitting section formed on the substrate, the light-emitting section being arranged in a center of the housing and the substrate being thermally connected to the thermal radiation section;
a pair of power-supply sections arranged around the light-emitting section in the housing and configured to supply electric power to the light-emitting module;
an information circuit arranged in a position around the light-emitting section and different from positions of the pair of power-supply sections in the housing and configured to output information to the outside;
a plurality of pins provided at intervals along a rear side peripheral portion of the housing around the projection; and
connecting means for connecting the power-supply sections and the pins located near the power-supply sections and connecting the information circuit and the pin located near the information circuit; and
a socket to which the lamp device is attached.

7. The luminaire according to claim 6, wherein the information circuit includes a temperature detecting section configured to detect temperature and output temperature information.

8. The luminaire according to claim 6, wherein the information circuit includes a lamp-characteristic output section configured to output lamp characteristic information.

9. The luminaire according to claim 6, wherein
the information circuit is arranged along an inner side surface of the projection,
a temperature detecting section configured to detect temperature and output temperature information is arranged on the thermal radiation section side, and
a lamp-characteristic output section configured to output lamp characteristic information is arranged on an opposite side of the thermal radiation section side.

10. The luminaire according to claim 6, wherein
the pins located in one region of two regions formed by dividing a region of the rear side peripheral portion of the housing into two and the power-supply sections are connected, and
the pin located in the other region and the information circuit are connected.

11. The luminaire according to claim 6, further comprising a lighting circuit configured to convert alternating-current power into predetermined direct-current power and supply the direct-current power to the lamp device and receive information signal output from the lamp device and control the lamp device.
